(19) United States
(12) Patent Application Publication
(10) Pub. No.: US 2026/0124810 A1
(43) Pub. Date: May 7, 2026

(54) DEVICE AND METHOD FOR DEBRIS DETECTION IN THREE-DIMENSIONAL PRINTING APPARATUS

(71) Applicant: SprintRay, Inc., Los Angeles, CA (US)

(72) Inventor: Shukun Ye, Los Angeles, CA (US)

(21) Appl. No.: 19/378,986

(22) Filed: Nov. 4, 2025

Related U.S. Application Data
(60) Provisional application No. 63/715,779, filed on Nov. 4, 2024.

(51) Int. Cl. B29C 64/393; B29C 64/124; B29C 64/241; B29C 64/245; B33Y 30/00; B33Y 50/02

(52) U.S. Cl. CPC B29C 64/393; B29C 64/124; B29C 64/241; B29C 64/245; B33Y 30/00; B33Y 50/02

(57) ABSTRACT

A three-dimensional printing subassembly is configured to detect debris within the photosensitive resin used within its resin tank. The subassembly includes a stepper motor configured to move a build platform with respect to the resin tank, and a motor step count module to count the motor steps initiated by the stepper motor during this movement. The subassembly analyzes information regarding the motor steps to determine information regarding lost motor steps and to ascertain the presence of debris within the resin.

### CROSS-REFERENCE TO RELATED APPLICATIONS

This application claims priority to U.S. Provisional Application No. 63/715,779 filed Nov. 4, 2024, the entire contents of which are hereby fully incorporated herein by reference for all purposes.

### TECHNICAL FIELD

The present disclosure relates generally to a 3D printing apparatus, and more particularly, to a 3D printing apparatus and method for debris detection.

### BACKGROUND

In the field of 3D printing, residual debris in the resin tank has long been a significant issue for users. If this debris is not detected and removed in a timely manner before printing begins, it can negatively impact the success of the print and potentially damage components of the 3D printing apparatus. For instance, residual debris may contaminate subsequent 3D-printed parts, leading to issues with their performance or appearance, and can even cause printing failures. Large pieces of debris in the resin tank may obstruct the build platform from descending to the appropriate position, particularly during the initial layer printing when the build platform must be at a specific height relative to the top surface of the resin tank. This obstruction can also lead to printing failures.

Additionally, debris can scratch the release film, also known as the separation film, of the resin tank. These scratches can result in unintended light scattering, which adversely affects the quality of the 3D-printed parts. Additionally, for 3D printing apparatus that includes an LCD screen as the display unit, residual debris may further lead to damage to the LCD screen.

Therefore, there is a need for a printing apparatus and method for debris detection that can accurately determine the presence of debris and pinpoint its location by analyzing changes in the detected values of the resistive screen within the build platform. This approach would effectively prevent damage to components and other issues caused by debris.

### SUMMARY OF THE INVENTION

The present invention discloses a printing apparatus and method for debris detection. The apparatus protects critical components of the printer, such as the resin tank and LCD screen, from potential damage caused by debris. The 3D printing apparatus comprises a detachable build platform with an embedded sensing assembly that includes a soft layer, resistive screen, and hard layer, all placed within a groove at the bottom of the build platform. The sensing assembly is configured to detect debris and prevent damage. The soft layer, made from materials like silicone, provides cushioning to protect the resistive screen, while the resistive screen itself is designed to identify debris presence and locate its position on the build platform. The hard layer acts as a robust surface for 3D printing while shielding the resistive screen from direct contact with resin, thus enhancing durability.

The resistive screen comprises an upper and lower electrode film separated by insulators, and can be implemented as a resistive touch screen or a force-sensing resistor. Upon contact with debris, the resistive screen identifies the precise location (x, y coordinates) of the obstruction using an Analog-to-Digital Converter (ADC) register. This system proactively detects debris, preventing it from coming into contact with the LCD screen and other sensitive parts of the 3D printer. Additionally, the sensing assembly is slightly elevated from the platform's surface to ensure debris contact is detected first, safeguarding the entire build platform and printer.

The system utilizes a stepper motor with controlled torque and step counting to detect potential obstructions within the resin tank. By employing precise step-counting techniques, the system monitors the build platform's movement from a defined zero position to a printing start position. It operates in a low-torque mode during descent, allowing for the detection of debris without applying excessive force that could damage the LCD screen if an obstruction is present.

The process includes lowering the build platform to an initial zero position, controlling its descent to the printing start position, recording steps during descent, returning the platform to the zero position, and calculating step differences to determine if debris is present. If the step difference exceeds a preset threshold, indicating debris, the system halts the printing process and alerts the user. Otherwise, printing continues under normal torque conditions.

This invention enhances the safety and reliability of resin-based 3D printers by offering a proactive solution for debris detection, ultimately improving the printer's longevity and minimizing maintenance requirements.

According to one aspect, one or more embodiments are provided below for a system and method for detecting debris within a three-dimensional printing subassembly, the three-dimensional printing subassembly comprising a resin tank, a stepper motor, and a build platform configured to be moved by the stepper motor, the method comprising using the stepper motor to cause a first movement of the build platform within the resin tank, collecting first information regarding one or more initiated motor steps initiated by the stepper motor while causing the first movement, based at least in part on the first information, determining a presence of at least one debris within the resin tank.

In another embodiment, the first information includes second information regarding one or more lost motor steps and/or third information regarding one or more successful motor steps of the one or more initiated motor steps.

In another embodiment, the determining the presence of at least one debris within the resin tank includes comparing the first information, the second information and/or the third information.

In another embodiment, the comparing the first information, the second information and/or the third information includes determining information regarding a total number of lost motor steps during the first movement of the build platform.

In another embodiment, the method further comprises comparing the information regarding the total number of lost motor steps to a predetermined threshold value to determine a significance of the information regarding the total number of lost motor steps.

In another embodiment, the information regarding the total number of lost motor steps is equal to or greater than the threshold value then the significance of the information regarding the total number of lost motor steps is set to high, and if the information regarding the total number of lost motor steps is less than the threshold value then the significance of the information regarding the total number of lost motor steps is set to low.

In another embodiment, the setting of the significance of the information regarding the total number of lost motor steps to high is a determination of the presence of at least one debris within the resin tank.

According to another aspect, a method is provided for detecting debris within a three-dimensional printing subassembly, the three-dimensional printing subassembly comprising a resin tank, a stepper motor, and a build platform configured to be moved by the stepper motor, the method comprising using the stepper motor to cause a first movement of the build platform from a first position to a second position within the resin tank, collecting first information regarding one or more first initiated motor steps initiated by the stepper motor while causing the first movement, using the stepper motor to cause a second movement of the build platform from the second position to the first position, collecting second information regarding one or more second initiated motor steps initiated by the stepper motor while causing the second movement, based at least in part on the first information and the second information, determining a presence or a non-presence of at least one debris within the resin tank.

In another embodiment, the method further comprises comparing the first information and the second information to determine information regarding a difference in initiated motor steps.

In another embodiment, the method further comprises comparing the information regarding a difference in initiated motor steps to a threshold value, wherein if the information regarding a difference in initiated motor steps is greater than the threshold value then determining the presence of the at least one debris within the resin, wherein if the information regarding a difference in initiated motor steps is less than the threshold value then determining the non-presence of the at least one debris within the resin.

In another embodiment, the method further comprises reducing the torque of the stepper motor from a normal operating torque mode to a reduced torque mode.

In another embodiment, the reduced torque mode includes implementing a lower operating current of the stepper motor compared to a normal operating current of the normal operating mode.

According to another aspect, a system for detecting debris within a three-dimensional printing system is provided comprising a resin tank, a stepper motor, a build platform configured to be moved by the stepper motor, a first positional sensor to sense a first position of the build platform, and a motor step count module configured to collect information regarding motor steps pertaining to the stepper motor as the stepper motor causes the build platform to move between a first position and a second position.

In another embodiment, the motor step count module is configured to collect first information regarding motor steps pertaining to the stepper motor as the stepper motor causes the build platform to move from the first position to the second position, and second information regarding motor steps pertaining to the stepper motor as the stepper motor causes the build platform to move from the second position to the first position.

In another embodiment, the motor step count module is configured to collect third information regarding lost motor steps pertaining to the stepper motor as the stepper motor causes the build platform to move from the first position to the second position, and fourth information regarding lost motor steps pertaining to the stepper motor as the stepper motor causes the build platform to move from the second position to the first position.

In another embodiment, the system further comprises an encoder configured to track the motor steps.

The presently disclosed system and method for evaluating growing media is more fully described in the detailed description below.

### BRIEF DESCRIPTION OF THE DRAWINGS

FIG. 1 illustrates an exploded view of the build platform and sensing assembly of a 3D printing apparatus, according to an embodiment of the invention.

FIG. 2A illustrates a perspective view of a resistive screen, according to an embodiment of the present invention.

FIG. 2B illustrates a cross-sectional view of the resistive screen at the contact point P, according to an embodiment of the present invention.

FIG. 3 illustrates a top view of the build platform, according to an embodiment of the present invention.

FIG. 4 illustrates a cross-sectional view of the build platform along line A-A of FIG. 3, according to an embodiment of the present invention.

FIG. 5 illustrates a working principle diagram of the upper electrode film and the lower electrode film, according to an embodiment of the present invention.

FIG. 6 illustrates the equivalent circuit diagram of FIG. 5, according to an embodiment of the present invention.

FIG. 7 illustrates a perspective view of the upper electrode film and the lower electrode film, the relative position of the sensing area, according to an embodiment of the present invention.

FIG. 8 illustrates the relationship between the voltage number VP at the contact point P and its x-coordinate x1 along the x-axis, according to an embodiment of the present invention.

FIG. 9 illustrates the relationship between the digital number QP at the contact point P and its coordinate x1 along the x-axis, according to an embodiment of the present invention.

FIG. 10 illustrates a flowchart of a method for debris detection in 3D printing apparatus, according to an embodiment of the present invention.

FIG. 11 illustrates a generalized block diagram of a debris detection device utilizing the stepper motor, according to an embodiment of the present invention.

FIG. 12 illustrates the debris detection assembly utilizing the stepper motor, according to an embodiment of the present invention.

FIG. 13 illustrates a flowchart of a control method, according to an embodiment of the present invention.

FIG. 14 illustrates a top view of the resin tank, according to an embodiment of the present invention.

### DETAILED DESCRIPTION OF EXAMPLE EMBODIMENTS

Example embodiments of the disclosure now will be described more fully hereinafter with reference to the accompanying drawings, in which example embodiments are shown. The concepts discussed herein may, however, be embodied in many different forms and should not be construed as limited to the example embodiments set forth herein; rather, these embodiments are provided so that this disclosure will be thorough and complete, and will fully convey the scope to those of ordinary skill in the art. Like numbers refer to like elements but not necessarily the same or identical elements throughout.

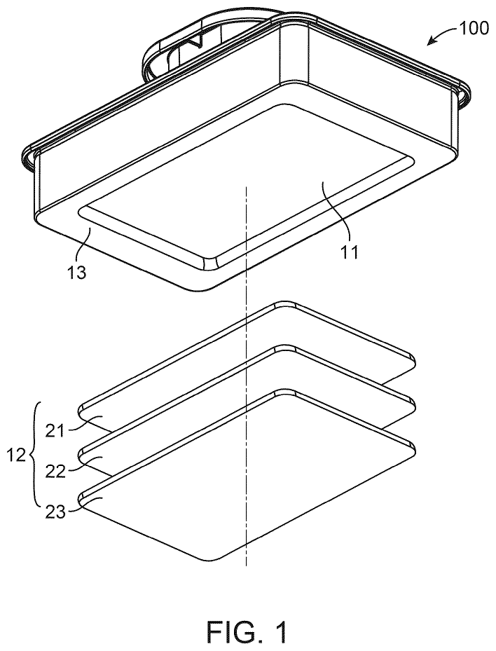

Referring to FIG. 1, a three-dimensional (3D) printing apparatus includes a detachable build platform 100. The build platform 100 includes a groove 11 extending horizontally at a central area of a bottom surface 13 of the build platform 100, and a sensing assembly 12 placed within the groove 11. The sensing assembly 12 comprises a soft layer 21, a resistive screen 22, and a hard layer 23, arranged sequentially from top to bottom. In one embodiment, the layers (21, 22, 23) are connected to each other through adhesive bonding or mechanical structure.

The soft layer 21 is connected on one side to the bottom of the groove 11 and on the other side to the resistive screen 22. This configuration provides a buffer for the resistive screen 22 when the sensing assembly 12 comes into contact with debris, thereby preventing damage to the resistive screen 22, the resin tank, and/or the LCD screen.

In one embodiment, the soft layer 21 is made of one or more soft materials including, but not limited to, rubber, silicone, TPE (Thermoplastic Elastomer), TPU (Thermoplastic Polyurethanes), with silicone being preferred. The thickness of the soft layer 21 may range from 0.6 mm to 1.2 mm, preferably between 0.6 mm and 0.8 mm. The Shore hardness of the soft layer 21 may range from 60 A to 80 A, preferably between 60 A and 70 A. The resistive screen 22 is placed between the soft layer 21 and the hard layer 23. The resistive screen 22 is configured to detect the presence of debris and pinpoint its position. The specific detection principle will be explained in detail later.

The hard layer 23 is placed beneath the resistive screen 22 and serves multiple purposes during the 3D printing process. It provides a surface on which 3D-printed parts or layers are formed, while also preventing the resistive screen 22 from coming into direct contact with the liquid photopolymer (or called, resin), thereby avoiding potential damage to the resistive screen 22. Furthermore, the hard layer 23 may be made from one or more materials such as glass, ceramic, or steel, with steel being preferred. In some exemplary embodiments, the bottom of the hard layer 23 may also be textured to enhance the adhesion of 3D-printed parts to the hard layer 23. The thickness of the hard layer 23 may range from 0.1 mm to 0.6 mm, preferably between 0.1 mm and 0.4 mm. The Brinell hardness of the hard layer 23 may range from 170 HB to 250 HB, preferably between 170 HB to 200 HB.

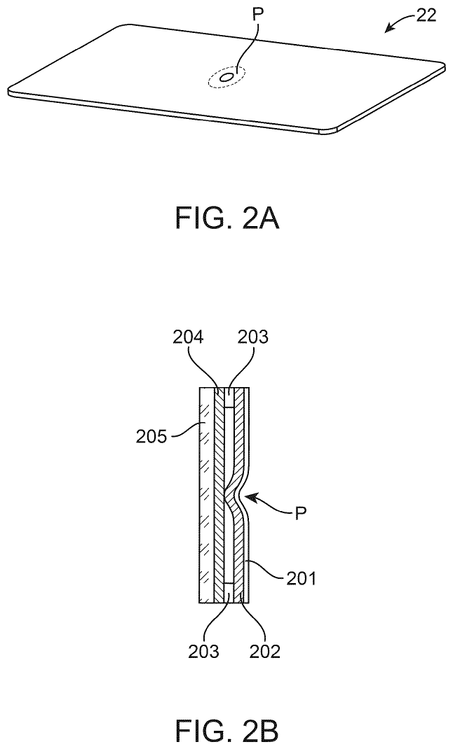

Referring to FIG. 2A and FIG. 2B, the resistive screen 22 includes an upper electrode film 202 and a lower electrode film 204, separated by insulators 203. Additionally, a protective film 201 is attached to the upper electrode film 202, while the lower electrode film 204 is affixed to a substrate 205. In one embodiment, the substrates 205 includes glass.

Alternatively, the resistive screen 22 can be a resistive touch screen (e.g., an AT080 touch screen provided by Innolux). However, this should not be limited that the resistive screen 22 is merely a preferred option in this exemplary embodiment. In some other exemplary embodiments, those skilled in the art may also replace it by a force-sensing resistor.

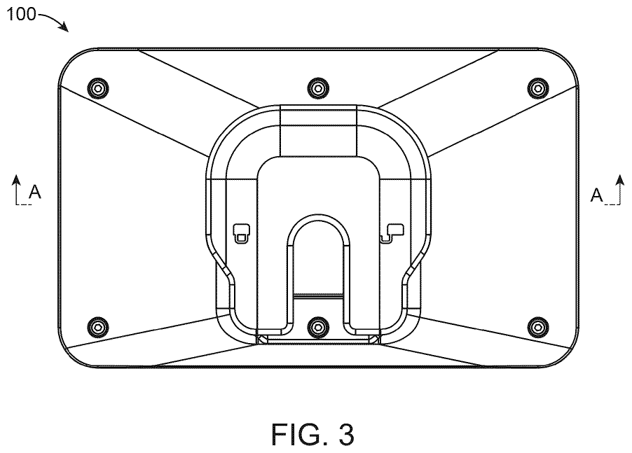

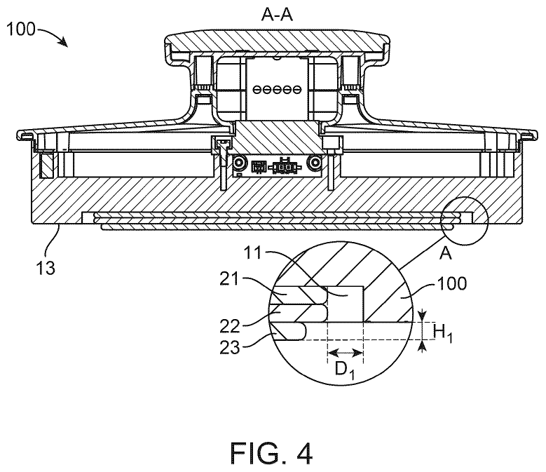

As previously mentioned, the sensing assembly 12 is placed in the groove 11 of the build platform 100. In some exemplary embodiments, as shown in FIG. 3 and FIG. 4, the sensing assembly 12 is placed in the central area of the groove 11, with a certain width of gap D₁ reserved between the sensing assembly 12 and the sidewalls of the groove 11 to facilitate sealing with adhesive. Preferably, D₁ may range from 1 mm to 2 mm.

At the same time, the sensing assembly 12 should protrude from the bottom surface 13 of the build platform 100. For instance, there should be a height H₁ between the bottom surface of the sensing assembly 12 and the bottom surface 13 of the build platform 100, to ensure that debris is first encountered and detected by the sensing assembly 12, preventing it from contacting the bottom surface 13 of the build platform 100, and ultimately preventing the undetected debris (which is outside the sensing area) damage some certain components of the 3D printing apparatus. Preferably, H₁ may range from 0.2 mm to 0.5 mm.

Additionally, the size (in horizontal) of the hard layer 23 can be the same as or slightly smaller than the sensing area (not shown in FIG. 4, refer to the sensing area 14 in FIG. 7) of the resistive screen 22. This ensures that no matter where the hard layer 23 comes into contact with debris, the resistive screen 22 will be able to detect it. Additionally, one or more routing holes can be reserved on the sides of the groove 11 to accommodate the routing of power lines for the resistive screen 22. Alternatively, besides filling the gap between the sensing assembly 12 and the sidewalls of the groove 11 with adhesive for sealing, other sealing methods can also be employed, such as using different fillers for sealing or mechanical sealing methods. In some exemplary embodiments, the resistive screen 22 is a resistive touchscreen, equipped with the function of detecting the presence and position of debris. The resistive screen is merely a preferred option in this exemplary embodiment, and in other exemplary embodiments, other sensing films with contact detection functionality may be used. In some exemplary embodiments, the soft layer 21 may be optional, but the resistive screen 22 (or other sensing film with detection functionality) and the hard layer 23 are essential.

In some exemplary embodiments, as shown in FIG. 7, a rectangular sensing area 14 is defined between the X+ and X− electrodes of the upper electrode film 202, as well as between the Y+ and Y− electrodes of the lower electrode film 204.

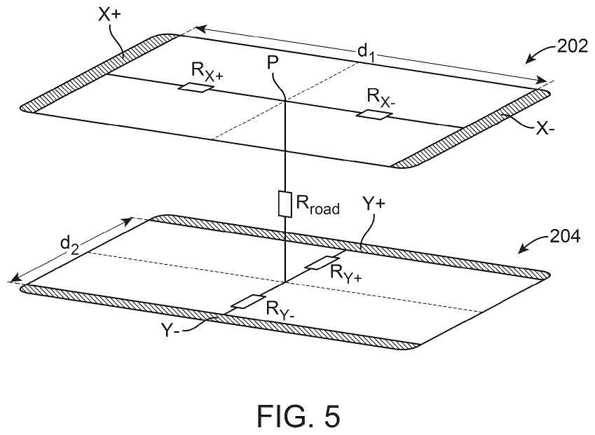

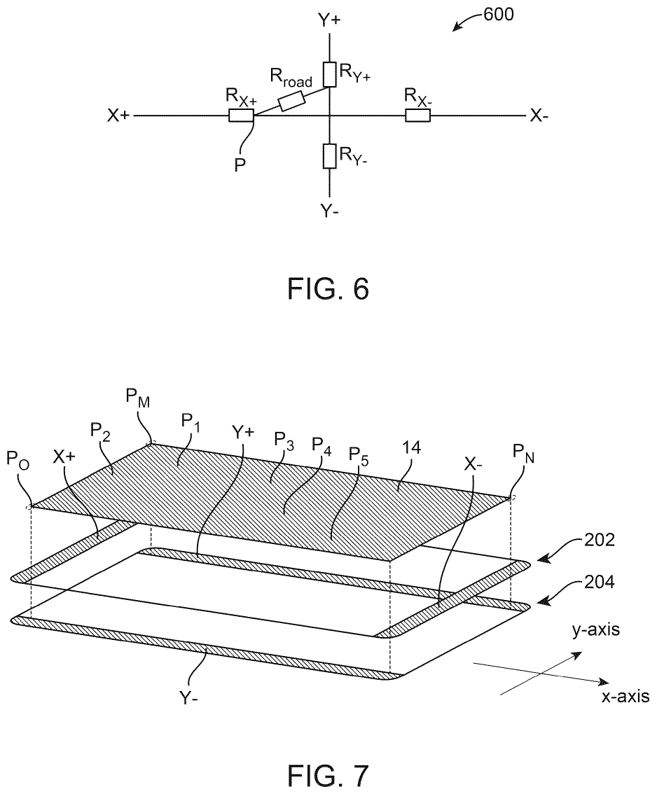

As shown in FIG. 5, and equivalent circuit diagram 600 of FIG. 6, the distance of the sensing area 14 in the x-axis direction is d₁ (i.e., the distance from electrode X+ to electrode X−), and the distance in the y-axis direction is d₂ (i.e., the distance from electrode Y+ to electrode Y−). The contact point P(x₁, y₁) represents the position of the debris to be detected.

In some exemplary embodiments, as shown in FIG. 5 and FIG. 6, an input voltage Vₛ can be applied to one of the electrode films 202 or 204, while the other electrode film is connected to an ADC (Analog-to-Digital Converter) register. For example, when detecting the x-coordinate x₁ of point P, the input voltage Vₛ can be applied to the X+ electrode of the upper electrode film 202, while the X− electrode is grounded. Simultaneously, the Y+ electrode of the lower electrode film 204 is connected to the ADC register to detect (or called, read) the digital number (Q_{P}).

It should be understood that an ADC register is configured to convert analog signals, much like an electronic device that converts an analog voltage into a digital number representing the magnitude of the voltage.

As shown in FIG. 7, the digital number and corresponding voltage number (V_{P}) at certain specific points have been pre-detected in advance. For instance, the digital number Q_{P} at the endpoints P_{M} (near the electrodes X+ and Y+), P_{N} (near X− and Y+), and P_{O} (near X+ and Y−) have been pre-detected by the ADC register, and the corresponding voltage number V_{P} have been obtained through D-A conversion. Additionally, the digital number and voltage number at other points within the sensing area 14, such as points P₁, P₂, P₃, P₄, and P₅, have also been detected or obtained for reference, as shown in Table 1 and Table 2 below:

TABLE 1
Applying voltage to the X+ electrode.

| | Q_{P} | V_{P} | x₁ |
|---|---|---|---|
| P_{M} | 4010 | 3.278 | 0 |
| P₁ | 3770 | 3.082 | 0.1175*d₁ |
| P₂ | 3780 | 3.090 | 0.1127*d₁ |
| P₃ | 2990 | 2.444 | 0.5000*d₁ |
| P₄ | 2450 | 2.003 | 0.7644*d₁ |
| P₅ | 2220 | 1.815 | 0.8771*d₁ |
| P_{N} | 1970 | 1.610 | d₁ |

TABLE 2
Applying voltage to the Y+ electrode.

| | Q_{P} | V_{P} | y₁ |
|---|---|---|---|
| P_{M} | 4005 | 3.273 | 0 |
| P₁ | 3560 | 2.910 | 0.2161*d₂ |
| P₂ | 3220 | 2.632 | 0.3815*d₂ |
| P₃ | 2740 | 2.240 | 0.6149*d₂ |
| P₄ | 2550 | 2.084 | 0.7077*d₂ |
| P₅ | 2120 | 1.733 | 0.9167*d₂ |
| Pₒ | 1950 | 1.593 | d₂ |

In this exemplary embodiment, when the sensing assembly 12 contacts debris at point P, the resistance from the endpoint P_{M} of the sensing area 14 to the contact point P is defined as R_{X+}, and the resistance from the opposite endpoint P_{N} to the contact point P is defined as R_{X-}. As the position of the contact point P changes along the x-axis, the resistances R_{X+} and R_{X-} will change accordingly, and the voltage number V_{P} at the contact point P will also change correspondingly.

$${V}_{P} = \frac{{R}_{X -}}{{R}_{X +} + {R}_{X -}} * {V}_{M} \qquad ( I )$$

Here, V_{M} represents the voltage number which is pre-detected at point P_{M}. However, it should be noted that in this exemplary embodiment, the voltage number V_{P} cannot be directly detected. Instead, it is converted from the digital number Q_{P} which is detected from the ADC register connected to the electrode Y+ of the lower electrode film 204. Once the system detect the digital number Q_{P}, it will obtain the voltage number V_{P} at the contact point P through D-A conversion.

$${V}_{P} = \frac{{Q}_{P}}{{Q}_{M}} * {V}_{M} \qquad ( II )$$

Here, Q_{M} represents the digital number of the sensing assembly 12 when it contacts debris at point P_{M}. Furthermore, through comparison with the voltage number V_{M} at point P_{M} on the upper electrode film 202, the x-axis coordinate x₁ of the contact point P can be calculated.

$${x}_{1} = \frac{{V}_{M} - {V}_{P}}{{V}_{M} - {V}_{N}} * {d}_{1} \qquad ( III )$$

Here, V_{N} represents the voltage number which is pre-detected at point P_{N}. Alternatively, in some exemplary embodiments, the x-axis coordinate x₁ of the contact point P can also be determined by using the digital number Q_{P} at the contact point P, along with the Q_{M} at point P_{M}, and Q_{N} at point P_{N} from the sensing assembly 12, as follows:

$${x}_{1} = \frac{{Q}_{M} - {Q}_{P}}{{Q}_{M} - {Q}_{N}} * {d}_{1} \qquad ( IV )$$

Similarly, the y-coordinate y₁ along y-axis of the contact point P can be detected using a similar method. For example, the input voltage Vₛ can be applied to the electrode Y+ of the lower electrode film 204, while the Y− electrode is grounded. At the same time, the X+ electrode of the upper electrode film 202 is connected to the ADC register to detect the digital number Q_{P}. The y-coordinate y₁ of the contact point P can then be determined by using the same or an alternative method as described above.

In some exemplary embodiments, as shown a graph 900 in FIG. 9, when the sensing assembly 12 does not come into contact with any debris, the digital number Q_{P} detected by the system typically falls between Qₘᵢₙ and Qₘₐₓ. Here, Qₘₐₓ represents the maximum number of the ADC register, and Qₘᵢₙ represents the minimum number of the ADC register, accounting for factors such as circuit influences.

When the digital number Q_{P} is within the range of [Qₘᵢₙ, Qₘₐₓ], it is generally considered that no debris is present in the area of the resin tank corresponding to the sensing assembly 12. The system conducts this detection before each printing operation begins. Preferably, the system continuously detects the number of Q_{P} during the printing of each layer, comparing it with pre-detected digital numbers such as Qₘᵢₙ, Qₘₐₓ, Q_{M}, Q_{N}, to determine if debris has been generated during the printing process.

When the digital number Q_{P} is within the range of [Q_{N}, Q_{M}], it is generally considered that debris is present in the area of the resin tank corresponding to the sensing assembly 12. The system can further detect the coordinates of the debris, P(x₁, y₁), using the aforementioned detection method. Then it outputs this information to the user, for example, by sending an alert via a display screen and indicating the exact position of the debris.

When the digital number Q_{P} is not within the range of [Qₘᵢₙ, Qₘₐₓ] or [Q_{N}, Q_{M}], it is generally considered that a malfunction has occurred in the sensing assembly 12 (or the resistive screen 22). The system can send an alert to the user, prompting them to perform a repair.

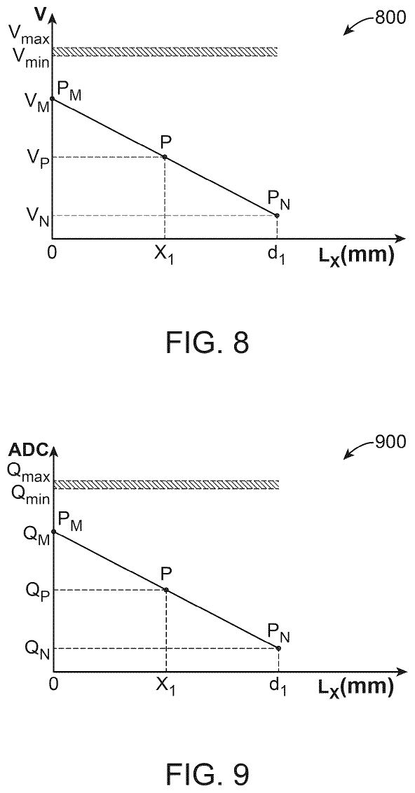

It is worth noting that, between the step 401 and the step 402, in addition to using the detected digital number Q_{P} for debris detection, the system can also utilize the detected voltage number V_{P}, as shown in graph 800 of FIG. 8, or other detected numbers.

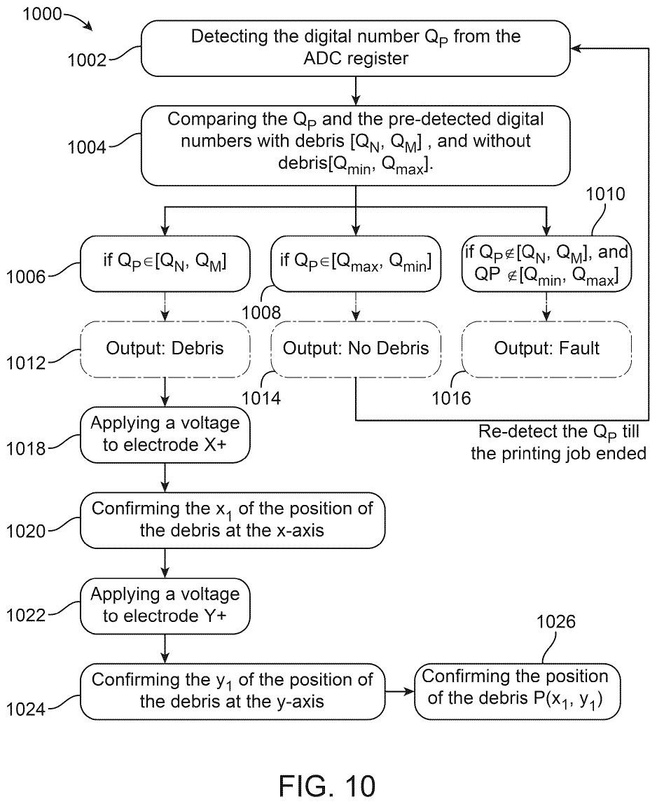

Alternatively, the present invention also provides another method in FIG. 10 and device for debris detection in 3D printing apparatus. At step 1000, the process begins with detecting the digital number Q_{P} from the ADC register. At step 1002, Q_{P} is retrieved for further analysis. At step 1004, Q_{P} is compared with pre-determined digital ranges, one indicating debris presence [Q_{N}, Q_{d}] and the other indicating no debris [Qₘᵢₙ, Qₘₐₓ]. At step 1006, if Qₚ falls within the debris range [Q_{N}, Q_{d}], the output is “Debris” (step 1012).

At step 1008, if Qₚ falls within the no-debris range [Qₘᵢₙ, Qₘₐₓ], the output is “No Debris” (step 1014).

At step 1010, if Qₚ is outside both the debris and no-debris ranges, the output is “Fault” (step 1016). If the output is “No Debris” or “Fault,” the process loops back to step 1004 to re-detect Qₚ until the printing job ends. At step 1018, if debris is detected, a voltage is applied to electrode X+ to determine the x-coordinate of the debris. At step 1020, the x− position of the debris is confirmed.

At step 1022, a voltage is applied to electrode Y+ to determine the y-coordinate of the debris. At step 1024, the y− position of the debris is confirmed, and the final position P(x, y) of the debris is established.

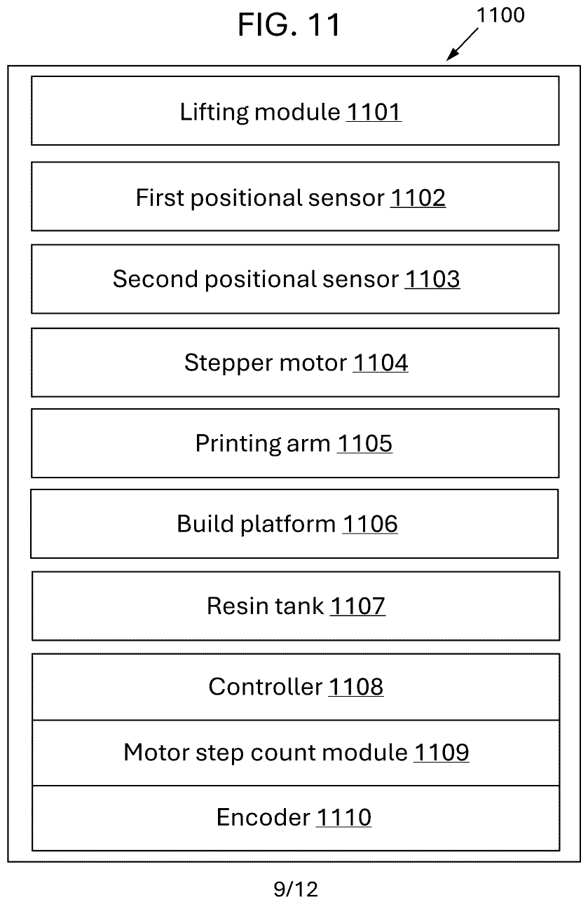

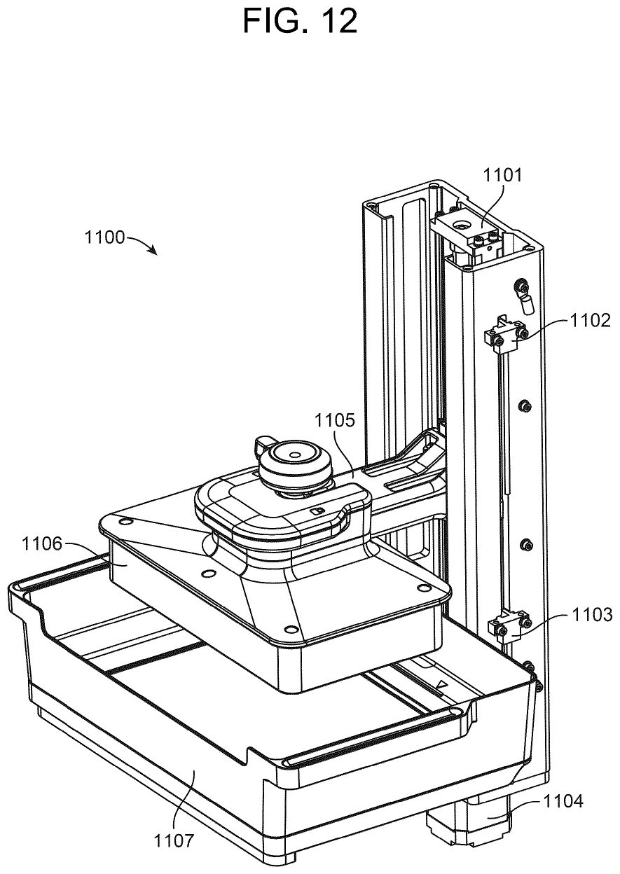

In some embodiments, as shown in FIGS. 11-14, an inventive subassembly 1100 may be used to determine the presence of debris within the resin.

FIG. 11 shows a generalized block diagram of a subassembly 1100 for use with a three-dimensional printing system including a lifting module 1101, a first positional sensor 1102, a second positional sensor 1103, a stepper motor 1104, a printing arm 1105, a build platform 1106, a resin tank 1107 to hold a volume of photosensitive resin, a controller 1108 to control aspects of the subassembly 1100 such as the stepper motor 1104, a motor step count module 1109, and an encoder 1110. While the motor step count module 1109 and the encoder 1110 are depicted as being a part of the controller 1108, it is appreciated that this is for ease of understanding and that the motor step count module 1109 and/or the encoder 1110 also may be a part of and/or configured with the stepper motor 1104 and/or with other elements of the subassembly 1100 as required.

In some embodiments, as shown as FIG. 12, the build platform 1106 is mounted on the printing arm 1105, which is configured with the lifting module 1101. The lifting module 1101, in conjunction with the stepper motor 1104, controls the vertical movement of the printing arm 1105 and the build platform 1106 attached thereto, e.g., upward and downward with respect to the resin tank 1107. The first positional sensor 1102 and the second positional sensor 1103 are located at opposite ends of the lifting module 1101 to sense the position(s) of the printing arm 1105. For example, in some embodiments, the first positional sensor 1102 may be located at an upper position along the lifting module 1101 to sense when the printing arm 1105 is at the upper position, and the second positional sensor 1103 may be located at a lower position along the lifting module 1101 to sense when the printing arm 1105 is at the lower position.

In some embodiments, the build platform 1106 may include a heating device, e.g., in its interior, for heating the resin within the resin tank 1107.

As described herein, the subassembly 1100 may be used to detect debris within the photosensitive resin within the resin tank 1107 that may be undesirable. As is known, the stepper motor 1104 may implement sequential motor steps to move the printing arm 1105 and the build platform 1106 attached thereto up and/or down along the lifting module 1101 one motor step at a time. During such movements, and as described herein, debris within the resin tank may obstruct the build platform 1106 and thereby cause the stepper motor 1104 to lose one or more motor steps during the build platform movement. That is, the stepper motor 1104 may attempt to implement a motor step (e.g., may initiate a motor step), but due to the obstruction, the motor step may not actually happen and the associated rotation of the stepper motor's drive shaft may not occur. As such, the number of initiated motor steps may not equal the number of actually implemented motor steps due to lost motor steps. Put another way, the total number of initiated motor steps may include the sum of successful motor steps and lost motor steps. As described herein, the subassembly 1100 may then utilize information regarding any lost motor steps to ascertain the presence of debris within the resin.

In some embodiments, in general, the stepper motor 1104 may be used to move the printing arm 1105 and the build platform 1106 along a discreet path along the lifting module 1101 between an upper position and a lower position, one or more times moving downward along the discreet path from the upper position to the lower position and one or more times moving upward between the lower position and the upper position along the same discreet path. During such movements, the motor step count module 1109 may collect information regarding the stepper motor's attempted motor steps, implemented motor steps, any lost motor steps, the position(s) of the build platform 1106 during and/or at the end of such movements, as well as other pertinent information.

For example, in some embodiments, the motor step count module 1109 may determine the number of motor steps attempted (e.g., initiated) and/or incurred by the stepper motor 1104 along the downward path and the number of motor steps attempted (e.g., initiated) and/or incurred along the upward path. If the stepper motor 1104 attempted and/or incurred more motor steps along the downward path compared to the upward path, then it may be ascertained that the stepper motor 1104 may have lost one or more motor steps during the downward movement that may be attributed to debris within the resin. In another example, if the build platform 1106 does not reach the lower position due to lost motor steps, the distance between the stopping point of the build platform 1106 and the lower destination point (e.g., the number of motor steps between the two locations) may be measured and/or used to calculate lost motor steps potentially due to debris.

In some embodiments, the information regarding the motor steps attempted, incurred and/or lost during the downward movement and/or the motor steps attempted, incurred and/or lost during the upward movement may be measured, calculated and/or otherwise determined using one or more methods.

For example, in some embodiments, an encoder 1110 may be configured with the motor step count module 1109 and/or with the stepper motor 1104 to track the rotational movements of the stepper motor's drive shaft. In this way, the encoder 1110 may be used to directly track (e.g., count) the step movements that the stepper motor 1104 successfully makes along the downward path and along the upward path. As mentioned above, if debris within the resin obstructs the build platform 1106 as the stepper motor 1104 attempts a motor step, the obstruction may cause the motor step to fail such that no corresponding rotational movement of the stepper motor's shaft occurs. After a failed motor step, the stepper motor 1104 may implement additional motor steps to ultimately reach its lower destination point. As such, the total number of attempted motor steps may be compared to the total number of actual motor steps sensed by the encoder 1110, and any difference between the two (e.g., a greater number of attempts vs. actually implemented motor steps) may indicate lost motor steps due to debris. Conversely, if the number of attempted motor steps generally equals the total number of motor steps tracked by the encoder 1110, this may indicate that no motor steps were lost and that no debris exists within the resin.

In another example, the distance that the build platform 1106 travels along the downward path may be compared to the distance traveled by the build platform 1106 along the upward path for the same number of attempted motor steps to determine if the stepper motor 1104 may have incurred lost motor steps along the downward path. For example, the stepper motor 1106 may receive a command to travel the distance between the upper position and the lower position and may in turn implement a number of motor steps to reach the lower position destination. However, if the stepper motor 1104 encounters debris that causes it to lose one or more motor steps along the way, the build platform 1106 may not reach the lower position, and instead, may reach and stop a distance above the lower point destination due to the lost motor steps. As such, the distance between where the stepper motor 1104 stops and the lower destination point may represent the number of lost motor steps along the downward path that may be attributed to debris within the resin. This distance may be referred to as a step loss distance.

Other methods also may be used to determine lost motor steps incurred by the stepper motor 1104 for the determination of debris within the resin.

Further details of the method(s) are provided below.

In some embodiments, the build platform 1106 (attached to the printing arm 1105) may be lowered to make contact with the second positional sensor 1103, which may establish a zero position (P₀) of the platform 1106. This position may be chosen to place the bottom build surface of the build platform 1106 at about 3 mm to about 15 mm above the interior bottom surface of the resin tank 1107, and preferably about 8 mm above the interior bottom surface of the resin tank 1107. Next, the stepper motor 1104 may move the build platform 1106 from the zero position P₀ (in a controlled descent phase) to a printing start position P₁ which may be chosen to preferably place the build surface of the build platform 1106 to a position generally established to begin the printing process, that is, e.g., to a position where there is only about one print layer gap between the interior bottom surface of the resin tank 1107 and the bottom build surface of the build platform 1106.

In some embodiments, during this downward movement, the motor step count module 1109 may count the motor steps and/or otherwise determine if the stepper motor 1104 incurs one or more lost motor steps as described herein. Next, the build platform 1106 may be moved upward from the lower position (e.g., from the printing start position P₁) to the zero position P₀ as the motor step count module 1109 continues to count the motor steps. The motor step information may be stored in memory.

In some embodiments, a threshold value T may be chosen and used during the analysis of the lost motor steps to determine resulting actions that the subassembly 1100 may take depending on the results, e.g., whether the subassembly 1100 should cease printing (e.g., if debris is present) or if the subassembly 1100 may continue printing (e.g., if no significant debris is present).

For example, in some embodiments, during the downward movement of the build platform 1106 from the zero position (P₀) to the printing start position P₁, the total number of downward motor steps (S_{d}) may be counted by the motor step count module 1109 and recorded as S_{d}=(P₁−P₀)*steps/mm where steps/mm is the number of motor steps incurred per millimeter of linear travel downward. In some embodiments, any lost motor steps along the downward path also may be added to and/or otherwise included in this total number of motor steps as appropriate (see above).

In some embodiments, during the subsequent upward movement of the build platform 1106 from the printing start position P₁ back to the zero position (P₀), the total number of upward motor steps may be counted by the motor step count module 1109 and recorded as Sᵤ=(P₀−P₁)*steps/mm where steps/mm is the number of motor steps incurred per millimeter of linear travel upward. In some embodiments, any lost motor steps along the upward path also may be added to and/or otherwise included in this total number of motor steps as appropriate (see above).

Subsequently, in some embodiments, the motor step difference (ΔS) between the downward and upward movements may be calculated (e.g., by the controller 1108), e.g., as ΔS=|S_{d}−Sᵤ|. Furthermore, the threshold value T may be defined for decision making purposes for determining when and if the debris may be deemed insignificant or significant. For example, if ΔS≤T then the number of lost motor steps may indicate that the resin does not include a significant amount of debris and the printing process may resume. However, if ΔS>T then the number of lost motor steps may indicate a significant amount of debris within the resin such that printing may halt and a warning may be issued to a user of the system alerting him/her of the problem.

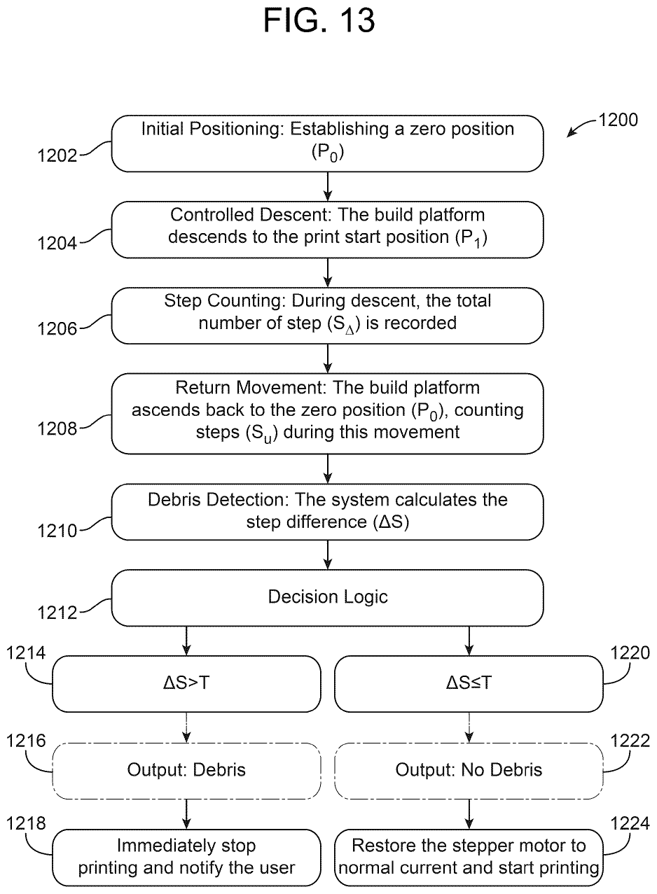

FIG. 13 illustrates a flowchart 1200 of a control method for identifying debris within a resin tank 1107, according to embodiments of the present invention. At step 1202, the build platform 1106 is lowered to establish a zero position, denoted as P₀. At step 1204, the build platform 1106 is controlled to descend to the print start position P₁. At step 1206, during the descent, the total number of motor steps Sa is recorded (e.g., by the motor step count module 1109). In some embodiments, this may include attempted motor steps, successfully implemented motor steps, and lost motor steps along this downward path. At step 1208, the build platform 1106 is controlled to ascend back to the zero position P₀ with the motor step count module 1109 counting the steps Sᵤ during this movement. In some embodiments, this also may include attempted motor steps, successfully implemented motor steps, and lost motor steps along this upward path. At step 1210, the controller 1108 calculates the step difference Aδ between S_{d} and Sᵤ for debris detection. At step 1212, decision logic (e.g., within the controller 1108) is applied to determine if debris is present based on the threshold T. For example, if ΔS>T at step 1214, the controller 1108 may determine that debris exists and at step 1216 may output “Debris”, after which at step 1218 the subassembly 1100 may immediately stop printing and notify the user. If, however, ΔS≤T at step 1220, the controller 1108 may determine that significant debris does not exist and at step 1222 may output “No Debris”. At step 1224, since no debris had been detected, the stepper motor 1104 may be restored to its normal operating conditions (e.g., normal operating current and torque) and printing may continue.

During movement of the build platform 1106, the following parameters of the printing arm 1105, build platform 1106, and/or stepper motor 1104 may be set, controlled, determined, measured, stored and/or otherwise taken into account (e.g., by the controller 1108).
a. Velocity (v): Preset low speed;
b. Acceleration (a): Controlled ramp-up;
c. Deceleration distance (d_{d}): Defined approach distance;
d. Motor current (Iₘ): Preferably set to a low value to limit torque; and
e. Torque limitation (Tmax): Tmax=kₜ*Iₘ, low-torque mode operation.

In some embodiments, it may be preferable to adjust one or more operating parameters during the debris detection process (e.g., one or more of the parameters (a)-(e) above) to ensure that any debris encountered during the process does not cause problems, e.g., does not cause damage to the LCD screen beneath the resin tank 1107.

For example, in some embodiments, it may be preferable to configure the stepper motor 1104 into a low torque mode so that if the build platform 1106 does encounter debris within the resin, that the stepper motor 1104 does not cause the build platform 1106 to press the debris downward at a sufficient torque that may cause damage to the LCD screen below.

To accomplish this, in some embodiments, the motor current of the stepper motor 1104 may be reduced from a typical maximum operating current of about 1.85 A (e.g., as controlled by the TMC2209 driver) to a limited motor current I_{M} of about 0.12 A (120 mA or about 2/32 of 1.85 A). This current reduction may be implemented through the IRUN register by setting its value to 1. This reduction in current also may reduce the stepper motor's torque thereby enabling controlled movement of the stepper motor 1104 while limiting the amount of downward force applied to the build platform 1106 during the movement. In this way, if debris is present, the build platform 1106 may not press the debris with excessive force into the top of the LCD beneath the resin tank 1107 thereby avoiding any damage that this may cause. In some embodiments, these settings may result in the speed of the stepper motor 1104 being about 0.4 mm/s.

In some embodiments, it may be preferable to limit the torque applied by the stepper motor 1104 to the build platform 1106 to a maximum allowed torque Tmax (e.g., corresponding to the limited motor current I_{M} and a torque constant kₜ of the motor 1104) wherein Tmax is chosen to (1) ensure that the stepper motor 1104 may lose at least one motor step when the build platform 1106 encounters significant debris within the resin, (2) to ensure that the stepper motor 1104 does not lose any motor steps as the build platform 1106 encounters resin without significant debris, and (3) to ensure that if the build platform 1106 does encounter debris within the resin, that the build platform 1106 does not exert sufficient force to the debris that may cause damage to the LCD screen below. This may be referred to as a low-torque mode of operation.

In some embodiments, a variety of factors may influence the value of the threshold T, such as, but not limited to, the viscosity of the resin, the speed of the stepper motor 1104, the size of build platform 1106 (e.g., the surface area of the build platform's build surface), the position and/or location of the debris within the resin tank 1107 (e.g., with respect to the build platform's build surface) and the shape/size of the debris. In some embodiments, the threshold T preferably may range from about 0.445 to about 0.8, with a preferred value of about 0.6.

In some embodiments, to determine a suitable threshold T, various tests and measurements may be conducted. For example, as mentioned above, a first criteria may be to establish a threshold T that ensures that the stepper motor 1104 does not lose motor steps when encountering resin with no debris. As such, the viscosity of the resin that may influence the threshold T value may be accounted for. Given this, as shown in Table 3 below, tests may be conducted to measure the step loss distance under “no debris” conditions using different assemblies (e.g., different subassemblies 1100) and/or different resins, e.g., with a stepper motor 1104 reduced current of 120 mA (e.g., low torque mode), a speed of 0.4 mm/s, and a deceleration distance of 0.75 mm. This experimental data is shown in Table 3 below.

TABLE 3
T measurements with no debris in resin

| | T with No Debris in Resin | | | | | | |
|---|---|---|---|---|---|---|---|
| | Test Number | | | | | | |
| Assembly No. | 1 | 2 | 3 | 4 | 5 | 6 | 7 |
| A | 0.285 | 0.32 | 0.325 | 0.325 | 0.28 | 0.28 | 0.32 |
| B | 0.285 | 0.36 | 0.28 | 0.325 | 0.32 | 0.4 | 0.2 |
| C | 0.32 | 0.285 | 0.28 | 0.445 | 0.32 | 0.2 | 0.24 |

In some embodiments, as seen from the Table 3, the maximum step loss distance of the stepper motor 1104 under “no debris” conditions within the resin tank 1107 was measured to be 0.445. Therefore, it may be preferable that the threshold T be set to at least 0.445 to avoid false detection of debris.

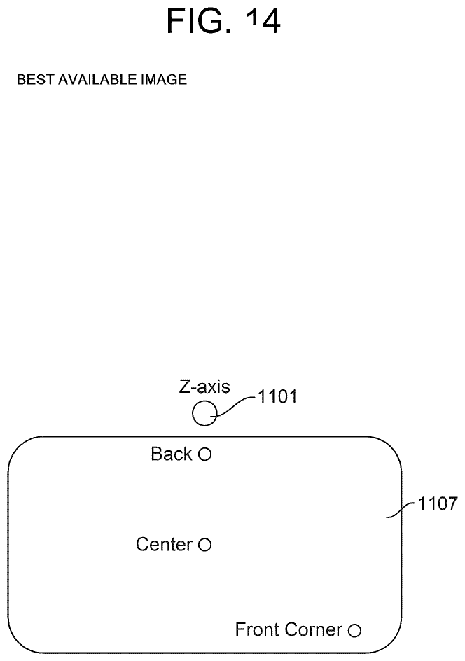

In some embodiments, the value of the threshold T also may be influenced by factors such as the location of the debris with respect to the build platform 1106 and/or the size of the debris (e.g., the diameter of the debris). For example, FIG. 14 shows different locations of potential debris with respect to the bottom build surface of the build platform 1106 including a back position, a center position, and a front corner position. Given this, as shown in Table 4 below, tests may be conducted to measure the step loss distance for debris located in different locations and with different diameters. This experimental data is shown in Table 4 below.

TABLE 4
T measurements vs. debris diameter and debris location

| | |
|---|---|
| | T at Different Debris Diameters |
| Debris | Debris Diameter |

| Location | 1.2 | 1.4 | 1.6 | 1.8 | 2.0 |
|---|---|---|---|---|---|
| Back | 0.645 | 0.845 | 1.04 | 1.285 | 1.405 |
| Center | 0.485 | 0.68 | 0.845 | 1.045 | 1.205 |
| Front Corner | 0.28 | 0.485 | 0.485 | 0.68 | 0.88 |

In some embodiments, based on the above information, the threshold T may preferably be set to be about 0.445 to about 0.645, and preferably to about 0.6. Notably, in some embodiments, the presence of small-diameter debris (e.g., debris with diameters less than a single layer's printing height) may not cause the LCD screen to crack or otherwise be damaged and may therefore be ignored by the subassembly 1100. As such, the subassembly 1100 may preferably detect and flag larger-diameter debris that may cause damage to the LCD screen while ignoring smaller diameter debris that may not necessarily cause problems.

Furthermore, in some embodiments, the value of the threshold T also may be influenced by the speed of the stepper motor 1104, the size of build platform 1106 (e.g., the surface area size of the build platform's build surface) and/or the parallelism of the build platform 1106 with respect to the interior bottom of the resin tank 1107. As such, it also may be preferable for the subassembly 1100 to also take these aspects into consideration.

Advantageously, this invention introduces an assembly and method for detecting debris in 3D printing, including aspects such as low-torque motor settings, dual-direction step counting, and adaptive threshold settings. The low-torque motor settings allow for safe obstruction detection, minimizing the risk of damage if the printer encounters debris. Dual-direction step counting enhances accuracy by considering movement in both directions, ensuring precise detection of any obstructions. Additionally, the adaptive threshold setting may make adjustments based on specific printer characteristics, allowing for flexible and optimized detection across different printer models.

As described herein, the system determines the presence of debris in the resin tank's sensing area by analyzing changes in the detected digital number Q_{P} or voltage number V_{P}, effectively preventing issues such as resin tank damage, LCD screen damage, and potential printing failures caused by debris. While the sensing assembly is intended for integration into various products, modifications may be necessary during the integration process to accommodate different product requirements and maintain system effectiveness.

Although the features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A method for detecting debris within a three-dimensional printing subassembly, the three-dimensional printing subassembly comprising:
a resin tank;
a stepper motor; and
a build platform configured to be moved by the stepper motor;
the method comprising:
using the stepper motor to cause a first movement of the build platform within the resin tank;
collecting first information regarding one or more initiated motor steps initiated by the stepper motor while causing the first movement;
based at least in part on the first information, determining a presence of at least one debris within the resin tank.

2. The method of claim 1 wherein the first information includes second information regarding one or more lost motor steps and/or third information regarding one or more successful motor steps of the one or more initiated motor steps.

3. The method of claim 2 wherein the determining the presence of at least one debris within the resin tank includes comparing the first information, the second information and/or the third information.

4. The method of claim 3 wherein the comparing the first information, the second information and/or the third information includes determining information regarding a total number of lost motor steps during the first movement of the build platform.

5. The method of claim 4 further comprising:
comparing the information regarding the total number of lost motor steps to a predetermined threshold value to determine a significance of the information regarding the total number of lost motor steps.

6. The method of claim 5 wherein if the information regarding the total number of lost motor steps is equal to or greater than the threshold value then the significance of the information regarding the total number of lost motor steps is set to high, and if the information regarding the total number of lost motor steps is less than the threshold value then the significance of the information regarding the total number of lost motor steps is set to low.

7. The method of claim 6 wherein the setting of the significance of the information regarding the total number of lost motor steps to high is a determination of the presence of at least one debris within the resin tank.

8. A method for detecting debris within a three-dimensional printing subassembly, the three-dimensional printing subassembly comprising:
a resin tank;
a stepper motor; and
a build platform configured to be moved by the stepper motor;
the method comprising:
using the stepper motor to cause a first movement of the build platform from a first position to a second position within the resin tank;
collecting first information regarding one or more first initiated motor steps initiated by the stepper motor while causing the first movement;
using the stepper motor to cause a second movement of the build platform from the second position to the first position;
collecting second information regarding one or more second initiated motor steps initiated by the stepper motor while causing the second movement;
based at least in part on the first information and the second information, determining a presence or a non-presence of at least one debris within the resin tank.

9. The method of claim 8 further comprising:
comparing the first information and the second information to determine information regarding a difference in initiated motor steps.

10. The method of claim 9 further comprising:
comparing the information regarding a difference in initiated motor steps to a threshold value;
wherein if the information regarding a difference in initiated motor steps is greater than the threshold value then determining the presence of the at least one debris within the resin;
wherein if the information regarding a difference in initiated motor steps is less than the threshold value then determining the non-presence of the at least one debris within the resin.

11. The method of claim 8 further comprising:
reducing the torque of the stepper motor from a normal operating torque mode to a reduced torque mode.

12. The method of claim 11 wherein the reduced torque mode includes implementing a lower operating current of the stepper motor compared to a normal operating current of the normal operating mode.

13. A system for detecting debris within a three-dimensional printing system comprising:
a resin tank;
a stepper motor;
a build platform configured to be moved by the stepper motor;
a first positional sensor to sense a first position of the build platform; and
a motor step count module configured to collect information regarding motor steps pertaining to the stepper motor as the stepper motor causes the build platform to move between a first position and a second position.

14. The system of claim 13 wherein the motor step count module is configured to collect first information regarding motor steps pertaining to the stepper motor as the stepper motor causes the build platform to move from the first position to the second position, and second information regarding motor steps pertaining to the stepper motor as the stepper motor causes the build platform to move from the second position to the first position.

15. The system of claim 13 wherein the motor step count module is configured to collect third information regarding lost motor steps pertaining to the stepper motor as the stepper motor causes the build platform to move from the first position to the second position, and fourth information regarding lost motor steps pertaining to the stepper motor as the stepper motor causes the build platform to move from the second position to the first position.

16. The system of claim 13 further comprising:
an encoder configured to track the motor steps.
